(19) United States
(12) Patent Application Publication
(10) Pub. No.: US 2009/0177692 A1
(43) Pub. Date: Jul. 9, 2009

(54) DYNAMIC CORRELATION OF SERVICE ORIENTED ARCHITECTURE RESOURCE RELATIONSHIP AND METRICS TO ISOLATE PROBLEM SOURCES

(76) Inventors: Byran Christopher Chagoly, Austin, TX (US); Byron Christian Gehman, Round Rock, TX (US); Sandra Lee Tipton, Austin, TX (US); Andrew Jason Lavery, Austin, TX (US)

Correspondence Address: IBM CORPORATION (RHF), C/O ROBERT H. FRANTZ, P. O. BOX 23324, OKLAHOMA CITY, OK, 73123, US

(21) Appl. No.: 11/969,365

(22) Filed: Jan. 4, 2008

(51) Int. Cl. G06F 17/30

(52) U.S. Cl. 707/104.1; 707/E17.044

(57) ABSTRACT

A potential multicomputer related problem is predicted and reported by determining a set of computer resources and relationships there between needed to complete a multicomputer business transaction, retrieving performance monitoring metrics for the computer resources during executions of the multicomputer transaction, dynamically deriving correlations between the resource relationships and the performance metrics, comparing a trend of the correlations to one or more service level requirements to predict one or more potential future violations of a business transaction requirement, including identification of one or more related resources likely to cause the violation, and reporting such prediction and likely case to an administrator.

### CROSS-REFERENCE TO RELATED APPLICATIONS (CLAIMING BENEFIT UNDER 35 U.S.C. 120)

None.

### FEDERALLY SPONSORED RESEARCH AND DEVELOPMENT STATEMENT

This invention was not developed in conjunction with any Federally sponsored contract.

### MICROFICHE APPENDIX

Not applicable.

### INCORPORATION BY REFERENCE

None.

### BACKGROUND OF THE INVENTION

1. Field of the Invention

The present invention relates to systems and methods for determining causes and sources of problems, errors, and inefficiencies in service oriented architecture computing environments.

2. Background of the Invention

Whereas the determination of a publication, technology, or product as prior art relative to the present invention requires analysis of certain dates and events not disclosed herein, no statements made within this Background of the Invention shall constitute an admission by the Applicant of prior art unless the term “Prior Art” is specifically stated. Otherwise, all statements provided within this Background section are “other information” related to or useful for understanding the invention.

In today's Information Technology (“IT”) system management environment, basic resource monitoring is becoming a commodity. For systems management companies to remain competitive they must move up the monitoring and management stack. Certain IT products, such as Tivoli's™ IT Service Management (“ITSM”) and IT Infrastructure Library (“ITIL”) provide a mechanism and methodology to achieve this. In the IT industry today, customers are moving their mission critical applications onto the Internet and providing them as services in a service oriented architecture (“SOA”) as to enable tighter integration. SOA is a well known style of computing environments which covers all aspects of developing, deploying, and using business processes which are accessed as “services”, for the entire lifecycle of each service.

The advantage of providing business transactions as SOA services (“SOAs”) is that it de-couples the business transaction from the underlying IT infrastructure and technical implementation that drives the transaction. Unfortunately, this makes management of such an environment even more complicated because the link between the business transaction and the IT resource that is servicing that transaction is not clear.

A challenge in SOA management has become how to determine why a SOA transaction is not available or not performing up to its defined performance level, especially to a contractual service level such as a Service Level Agreement (“SLA”). The question of “What resource is causing the end user problem and why?” can plague administrators, but the complexity and fluidity of the SOA arrangement can make problem source determination incredibly difficult.

This is an industry wide problem and many of the available systems management products attempt to provide solutions. One such example is IBM Tivoli Monitoring (“ITM”) which is a resource monitoring product that monitors the individual servers and the metrics of the applications running on those servers. However, ITM does this without the context of the SOA transaction or the business impact of the application being monitored.

Another specific systems management product is IBM Tivoli Composite Application Manager (“ITCAM”) which monitors SOA transactions and tracks the transaction as it flows across the IT infrastructure. ITCAM dynamically discovers the IT resources involved in a SOA transaction and correlates which physical resource is the root cause of the response time problem, but it does not correlate the business impact to the application specific resource metric that caused the problem.

There are many other products in this market space that attempt to provide solutions to this problem, but do so in fragmented and incomplete ways. Another similar challenge is related to how companies currently attempt to manage this type of problem. Currently, many companies establish large management infrastructures and operations centers where they funnel all system and application events from all monitored applications. When a problem occurs, the Operations staff quickly becomes bombarded with thousands of IT resource system events indicating that there is some type of IT problem. It is up to the Operations staff to filter through these events and to attempt to understand which events impact the business and which are just “noise” (e.g. which events have little or no actual business impact). “Business impact” can be defined in many ways. In the case of the present invention, we are referring to business transaction response time and availability from an end user perspective. If a business cannot provide its online SOA transactions to its customers in a timely fashion, its business is directly impacted. But, the concepts and problems addressed herein are general to many of the broader definitions of business impact. Whether companies are attempting to service release management, configuration management, change control management, etc., there are always a vast set of key business metrics that are impacted by the IT infrastructure. The challenge, therefore, is to discover how to identify which specific IT metrics and resources are impacting the business adversely so that the issues can be effectively addressed.

### SUMMARY OF THE INVENTION

A potential multicomputer related problem is predicted and reported by determining a set of computer resources and relationships there between needed to complete a multicomputer business transaction, retrieving performance monitoring metrics for the computer resources during executions of the multicomputer transaction, dynamically deriving correlations between the resource relationships and the performance metrics, comparing a trend of the correlations to one or more service level requirements to predict one or more potential future violations of a business transaction requirement, including identification of one or more related resources likely to cause the violation, and reporting such prediction and likely case to an administrator.

### BRIEF DESCRIPTION OF THE DRAWINGS

The following detailed description when taken in conjunction with the figures presented herein provide a complete disclosure of the invention.

FIG. 1 shows a system of components arranged according to the present invention.

FIGS. 2a and 2b show a generalized computing platform architecture, and a generalized organization of software and firmware of such a computing platform architecture.

FIGS. 3a and 3b show examples of raw dissimilar metrics data and normalized dissimilar metrics data.

FIGS. 4a-4c, illustrate computer readable media of various removable and fixed types, signal transceivers, and parallel-to-serial-to-parallel signal circuits.

FIGS. 5a-5c illustrate topologies of business transaction systems and their sources of error messages and monitoring metrics.

FIG. 6 sets forth a logical process according to the invention for monitoring relationships and metrics of an arrangement such as those illustrated in FIGS. 5a-5c.

FIG. 7 depicts a logical process according to the invention for correlating monitoring statistics to resource relationships, and for predicting violations of service level agreement performance based on trends or correlations of performance criteria.

### DETAILED DESCRIPTIONS OF EXEMPLARY EMBODIMENTS OF THE INVENTION

The inventor of the present invention have recognized and solved problems previously unrecognized by others in the art of managing SOA-based computing arrangements. The inventor has recognized that a mechanism is needed which provides a complete end-to-end solution that can autonomically link IT resource metrics to SOA business transaction performance problems in order to allow SOA systems owners (“customers”) to quickly identify the root cause of a SOA transaction problem.

### SOA Architectures in General

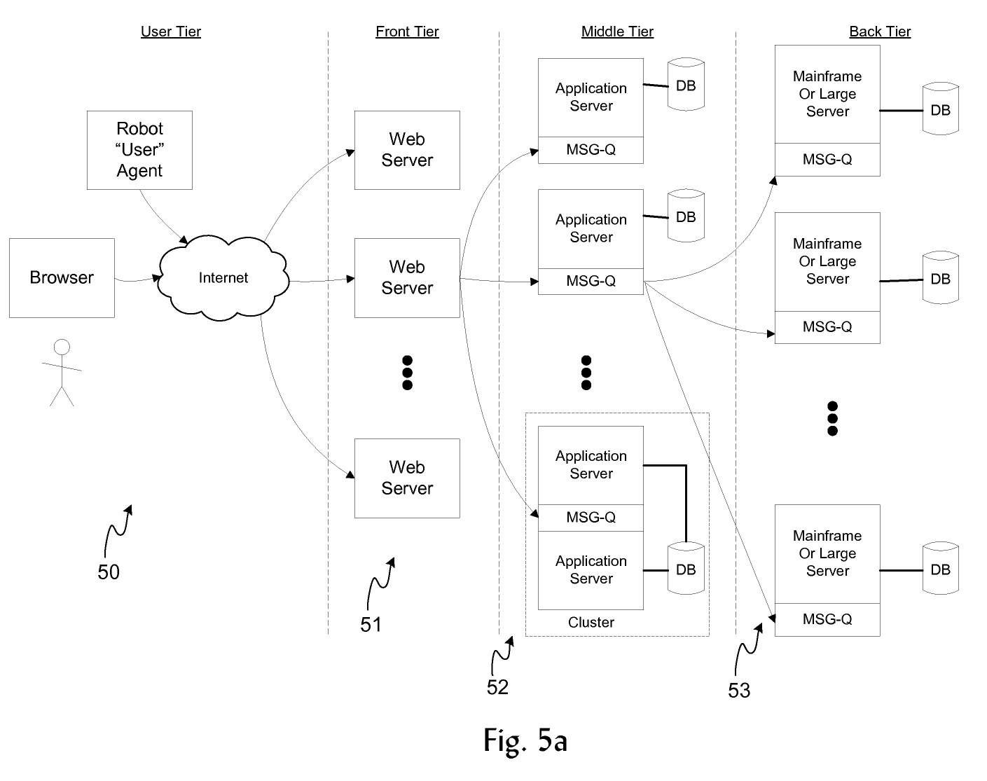

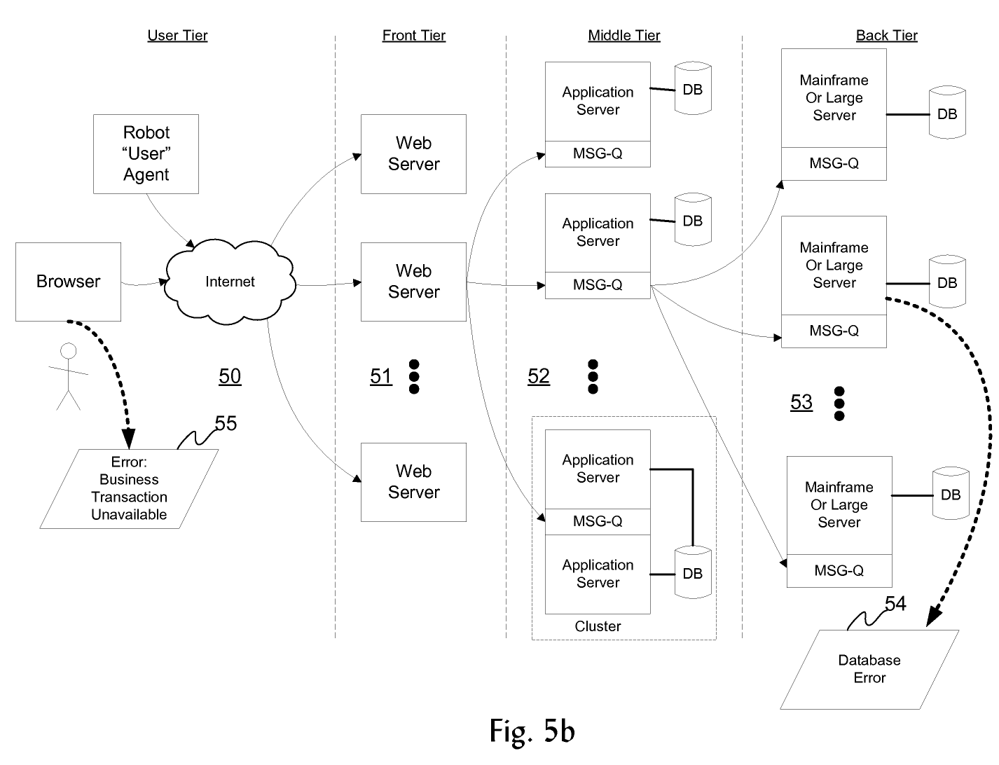

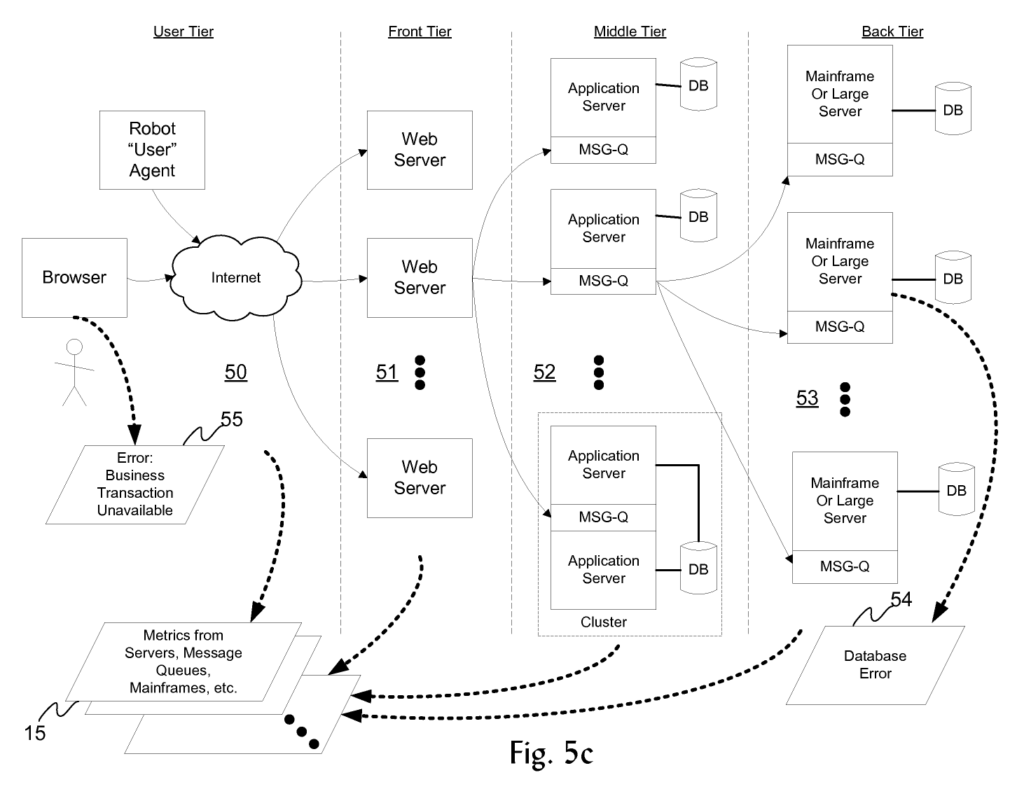

Turning to FIG. 5a, a generalized representation of an arrangement of computing systems and networks according to SOA is shown. A user tier (50) includes actual users, such as human users of web browser to request services, as well as “robotic agents” which are other programs and computers that appear to be human users requesting services. A “front tier” (51) includes many typical web servers, and “middle tier” (52) includes many application servers and associated databases, such as DB2 databases.

Finally, a “back tier” (53) includes many larger servers and mainframes, such as large computers running well-known operating systems and applications such as z/OS, CICS, Linux, UNIX, and IMS, as well as many associated databases. Most of the application servers and back tier systems are also outfitted with a messaging queue handler (“MSG-Q”), such as IBM's MQ series messaging product.

Present day correlation technology is event based. Alerts are only generated when a problem is detected. An administrator must define rules to correlate related events to sources or causes of problems. And, according to present day approaches, resource relationships are hard coded and defined by the administrator, in which a user defines systems related by business boundaries. But, these SOA systems frequently change roles and functions, making previous manually-defined relationships obsolete.

Further, present day expert advice and situation based thresholding and alerting are hard coded and based on generalized observations from previous customer experiences and what “should” happen.

Turning to FIG. 5b, a simplified example of an error event is shown. During a business service request or transaction initiated by a user or robot agent, a backend tier server's database throws an error such as having no free tablespace in which a new database record can be inserted. This causes creation of a first error report (54). But, because the SOA service was not completed, a user tier error report is also generated, such as a “business transaction unavailable” report (55). A system monitoring thousands, even millions, of simultaneous transactions will receive both of these reports among many others. The problem then arises how to know that these two problems, out of many reported, are relate, and if so, what is the actual root cause of the problem. In practice, each error, such as a backend tier database error, will result in many error reports, and a monitoring product will receive hundreds of reports in a short period of time, so making these determinations can be difficult to impossible.

### PROVISIONS OF THE INVENTION

The present invention provides an autonomic correlation engine that utilizes the existing resource relationships defined in monitoring products such as Tivoli's Configuration Management Database (“CMDB”) and the real time resource metrics defined in a data warehouse, like that provided by the Tivoli DataWarehouse and ITM, to dynamically discover and link SOA business transaction performance with the IT resource metrics that caused the business transaction violation. The invention's method for discovering such relationships is unique and provides significant business advantage to any company or product that can provide this capability as a SOA management solution.

To this end, the present invention provides these advantages and functions:
Application management software automatically identifies the resources involved in a business transaction.
Resources are stored in a system database such as CMDB.
Metrics from related resources are analyzed and correlated to determine metric relationships.
Correlation rules are automatically generated to detect and predict violations based on variations in correlated metrics.
Customers are no longer required to set predefined thresholds, the system simply detects and reports abnormalities in the monitored data.

Turning to FIG. 5c, an overview of information and messages according to the invention is shown. In addition to the normal error messages (54, 55), the invention collects or accesses collected metrics (15) from all of the various servers, message handlers, application programs, operating systems, and network management tools. For example, following the foregoing scenario of a database insert error, from the user tier, a metric indicating the response time on Server 1 may be collected, as well as a statistic of the number of open connections for Server 2 in the front tier. And, from the middle tier, a free thread pool count may be collected from Server 3 as well as a message queue channel wait time from Server 4. From the back tier, message queue reception indicators may be collected from a fifth server, and database free tablespace indicators may be collected from a sixth server.

As a result of the analysis and predictive methods of the invention, described in detail in the following paragraphs, it may be signaled to an administrator that because resource monitoring has detected a significant decrease in free tablespace on the sixth server below the normal level of free tablespace, business transactions of type 1 which use the affected database may exceed a performance threshold within 30 minutes according to tablespace usage trends.

### Arrangement of Components

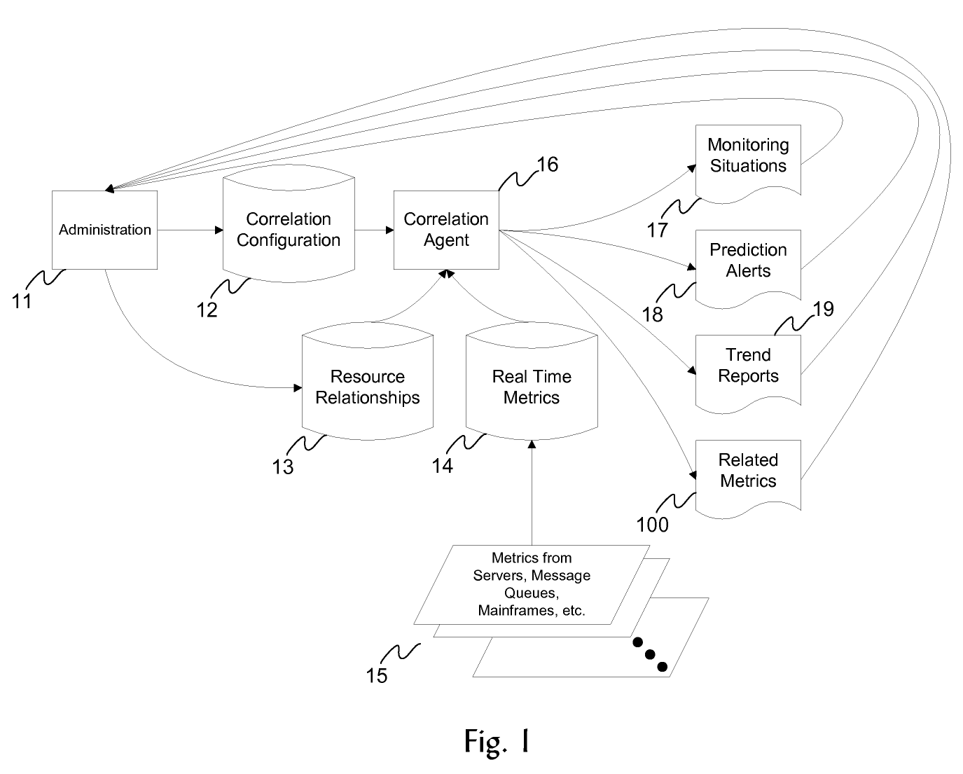

FIG. 1 illustrates a generalized arrangement (10) of components according to the invention for correlating the performance metrics, resource relationships, and problem reports to one or more sources of the error or performance degradation.
a. Business transactions are tracked (14) across multiple IT resources (15).
b. Resource relationships and real time resource metric data are stored in a management database (13).
c. The correlation agent (16) reads the metrics and relationship databases (13, 14), and determines which resource metrics cause business transaction performance or availability issues according to correlation process configuration parameters (12).
d. The correlation agent (16) uses trending information for the related metrics to determine if and when business level performance will be violated.
e. The correlation agent (16) sends alerts (17-19, 100) to an administrator (11) when it detects or predicts a performance objective violation.

According to one embodiment of the invention, the correlation agent provides the following outputs from such an analysis:
a. Rules for monitoring situations (17) for determining when resources violate a defined threshold;
b. Prediction Alerts (18) based on trending of correlated metric values;
c. Trend Reports (19) based on the correlated metric values; and
d. identification of related or correlated metrics and resources (100) in relation to the SOA business transactions.

### Logical Processes of Monitoring

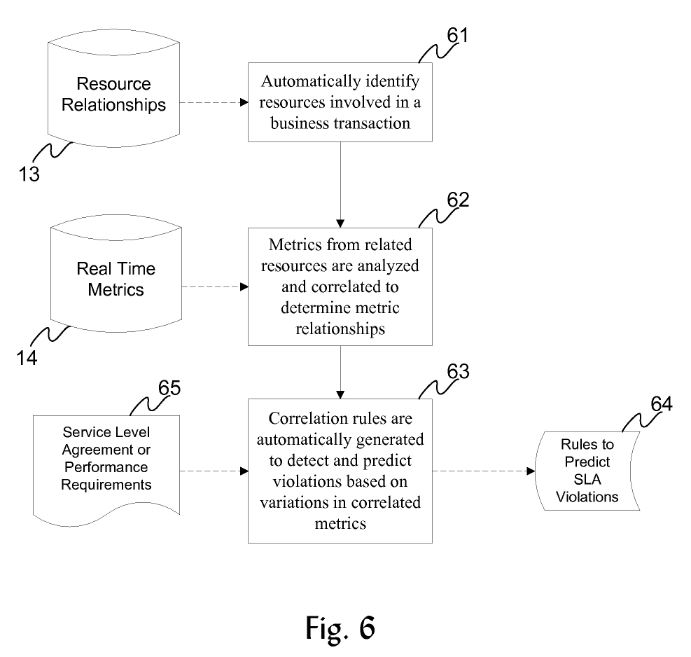

A generalized monitoring procedure according to the invention is shown in FIG. 6:
61. Application management software automatically identifies the resources involved in a business transaction. Resource relationships are stored in a management database.
62. Metrics from related resources are analyzed and correlated to determine metric relationships, assuming that the resources are commonly identified by a consistent global identifier such as Internet Protocol (“IP”) address, MAC address, etc.
63. Correlation rules (64) are automatically generated to detect and predict violations based on variations in correlated metrics and based on Service Level Agreement criteria (65).

As a result, customers are no longer required to set predefined thresholds, the system simply detects & reports abnormalities in the monitored data.

### Logical Processes of Correlation of Metrics, Relationships, Problem Reports to Error Sources

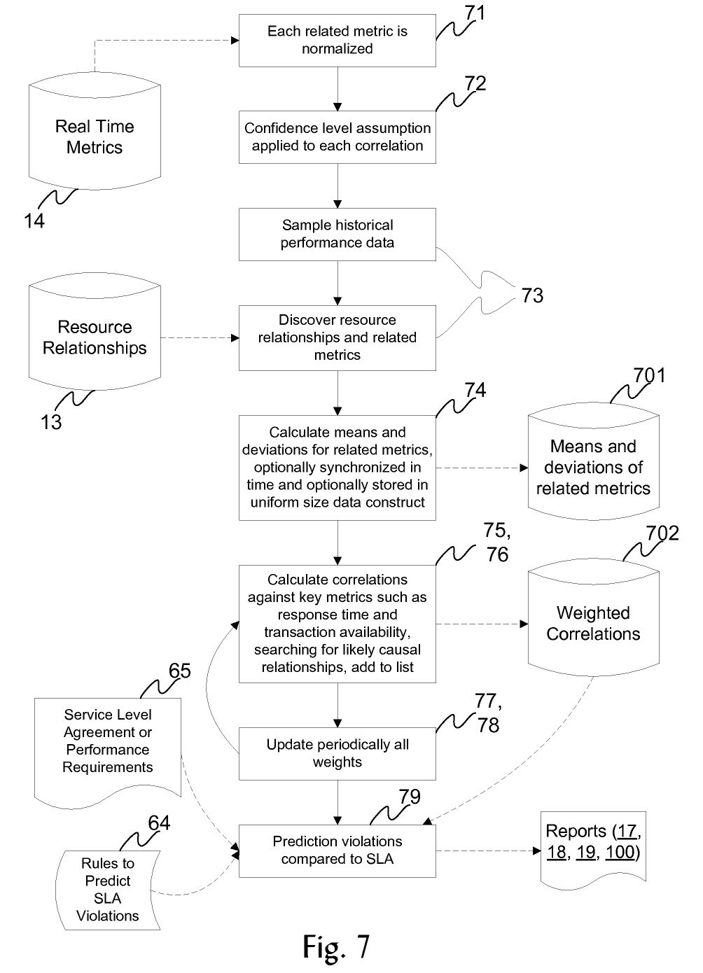

Turning to FIG. 7, a logical process for performing the correlation and trend analysis according to the invention is shown:
71. Each related metric is normalized to a range from 0 to 1 (or an alternative range as deemed necessary by the implementer);
72. A level of confidence in the correlations and predictions is assumed, such as 99.95%.
73. Historical performance data is sampled to discover resource relationships and related metrics.
74. Population means and standard deviations (701) are calculated for all related metrics. According to a preferred embodiment, time synchronization is leveraged, so times are synchronized across all SOA resources or time shifts are recorded for each resource. And, sampled data is stored in a predefined data construct size to make sampling and time synchronization more accurate. Another approach to time synchronization that may be employed in other embodiments is to record the time offset of each server relative to a central time server, and to synchronize the times at the central server when analyzing the data by adjusting event timestamps by the offset value associated with the reporting server.
75. Correlation (702) for each metric is calculated against the key metrics of transaction response time and transaction availability to determine causal relationship.
76. Each correlated metric is added to the list of related metrics, and a default weight is assigned to the listed metrics to determine how changes in this particular metric affect the overall response time.
77. The autonomic correlation agent updates the weights based on what it learns from its predictions and true violations to provide more accurate predictions in the future.
78. The correlation agent samples the collected metric data on regular intervals and uses that data to calculate the predicted response time.
79. If the predicted response time significantly deviates from its normal value, then a violation event or predicted violation event is generated. The metric that is most deviating from its normal, based on its weighted value, will be reported as the cause of the violation. If multiple metrics are equally violating then it would indicate the list of violating metrics.

### Normalization of Metrics Information

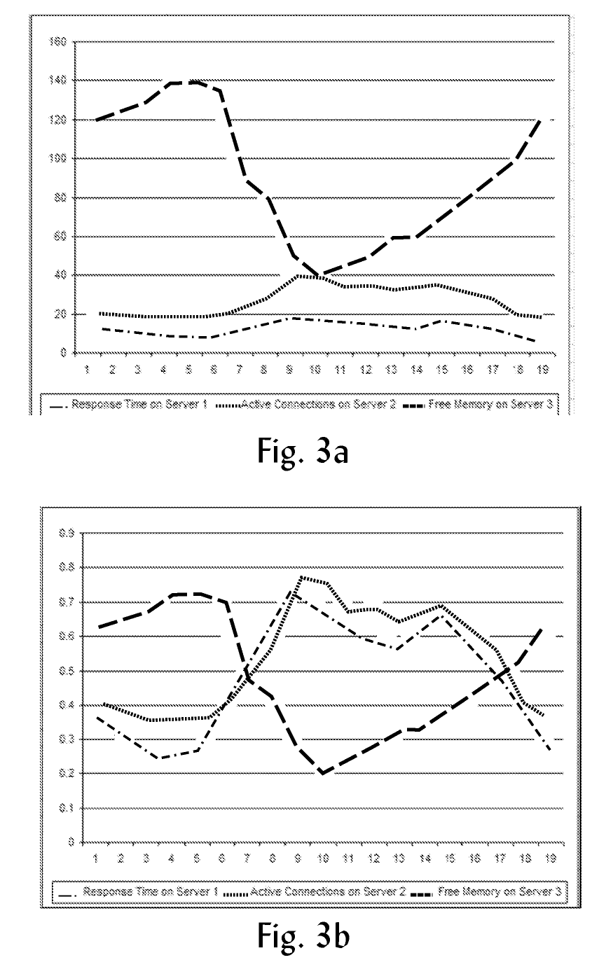

In order to effectively compare dissimilar metrics, a method was developed to render the metrics to a form which is readily and meaningfully comparable. FIG. 3a shows three dissimilar metrics—response time on Server 1, active number of connections on Server 2, and free memory on Server 3. Plotted over time (x-axis) with varying vertical axis units, the curves are of little informational value relative to each other.

However, by normalizing all three metrics data to a common range, such as 0 to 1, as shown in FIG. 3b, the curves begin to provide useful information relative to each other.

One can see that once the data is normalized, it is more straightforward and meaningful to calculate a correlation coefficient to determine if the metrics are directly or inversely related to the key metric of SOA transaction response time. From this example of FIGS. 3a and 3b, it can be determined that the metric regarding active connections on Server 2 is directly correlated to response time, and the free memory metric for Server 3 is inversely related to response time.. When the number of active connections goes up, so does the response time. And, when the free memory decreases, the response time increases.

Such normalization, as previously disclosed as a step in a larger logical process, is useful for the present invention whereas the many metrics to be compared and monitored are often dissimilar in units and quantity ranges.

### Correlation Configuration Parameters

As shown in FIG. 1, an administrator is provided one or more configuration parameters (12) to control the operation of the correlation agent (16). These may include, but are not limited to:
(a) A threshold or other limit to be used to determine what level of change in a metric is to be considered as a significant change, such as one times the standard deviation of the data over time, a 20% change over a windowed average of the data, etc.
(b) A number of occurrences of an event, which when met or exceeded, should trigger production of a performance failure prediction, such as 30 or more events, etc.
(c) A correlation certainty or accuracy requirement or threshold in order for a prediction or error to be reported, such as 99.95%.
(d) A “normal” level or state of each metric.

### Real Time Metrics Database Schema

It will be recognized by those skilled in the art that many schemas may be adopted for use with the logical processes of the present invention. By way of more complete illustration of an example embodiment of the present invention, one possible schema for such a database is (e.g. the column names and data types for the fields in each metric record or row):
1. Timestamp—The time the correlated event was generated.
2. ApplicationName—The business application affected.
3. TransactionName—The name of the business transaction affected.
4. TransactionMonitorType—The monitor type that recorded this transaction.
5. ResourceMetricName—The resource metric that is the root cause of the business transaction problem.
6. ResourceMonitorType—The resource monitor that collected the resource metric.
7. ServerName—The server that is the root cause of the problem.
8. ServerID—The internal monitoring system id for the server.
9. ViolationType—The type of violation: Performance, Availability, Predicted Performance, Predicted Availability
10. ExpectedValue—The expected normal value for the metric.
11. ActualValue—The actual current value of the metric.
12. PredictedFutureValue—The predicted value of the metric at ViolationTime if in the future.
13. ViolationTime—The predicted violation time in the future, or a historical time if the event has already occurred.

### Additional Correlation Functionalities

According to other embodiments of the invention, such an application may further provide the following functionality:
(a) Different personas identify different metrics as key and would be able to report on the related metrics that impact that particular key metric.
(b) Alerts can be sent when any key metric is predicted to violate and the root cause identified.
(c) The system can use discovery methods to detect the ‘normal’ state of the metrics, and to confirm this assumption of “normal” metrics by querying an administrator if this is a good state or bad state of operation or performance.
(d) The system can automatically generate correlation rules and present them to an administrator to determine which rules are important to the business entity. An administrator may adjust the automatically generated rules to more closely match their business requirements.
(e) The system can identify causal relationships by time. For example, the one that happens first in a set of related metrics may be assumable as the probable cause.
(f) The system can provide and use one or more templates for correlation patterns. For example, the default action should be to send an alert to the operations staff.
(g) The system can track the unmonitored metrics, detecting missing or lacking of monitoring. If a particular key metric spikes or dips sharply and no other metrics spike or dip sharply in correlation, then a lack of monitoring in that an unmonitored metric may be deemed to have caused the spike or dip (e.g. a lurking variable or confounding factor).
(h) The system may display one or more graphs of related metrics over time to allow manual visualization of interrelationships between metrics and performance attributes, thereby predicting problems with leading indicators, and suppressing problems from lagging indicators.

### Suitable Computing Platform

Whereas at least one embodiment of the present invention incorporates, uses, or operates on, with, or through one or more computing platforms, and whereas many devices, even purpose-specific devices, are actually based upon computing platforms of one type or another, it is useful to describe a suitable computing platform, its characteristics, and its capabilities.

Therefore, it is useful to review a generalized architecture of a computing platform which may span the range of implementation, from a high-end web or enterprise server platform, to a personal computer, to a portable PDA or wireless phone.

In one embodiment of the invention, the functionality including the previously described logical processes are performed in part or wholly by software executed by a computer, such as personal computers, web servers, web browsers, or even an appropriately capable portable computing platform, such as personal digital assistant (“PDA”), web-enabled wireless telephone, or other type of personal information management (“PIM”) device. In alternate embodiments, some or all of the functionality of the invention are realized in other logical forms, such as circuitry.

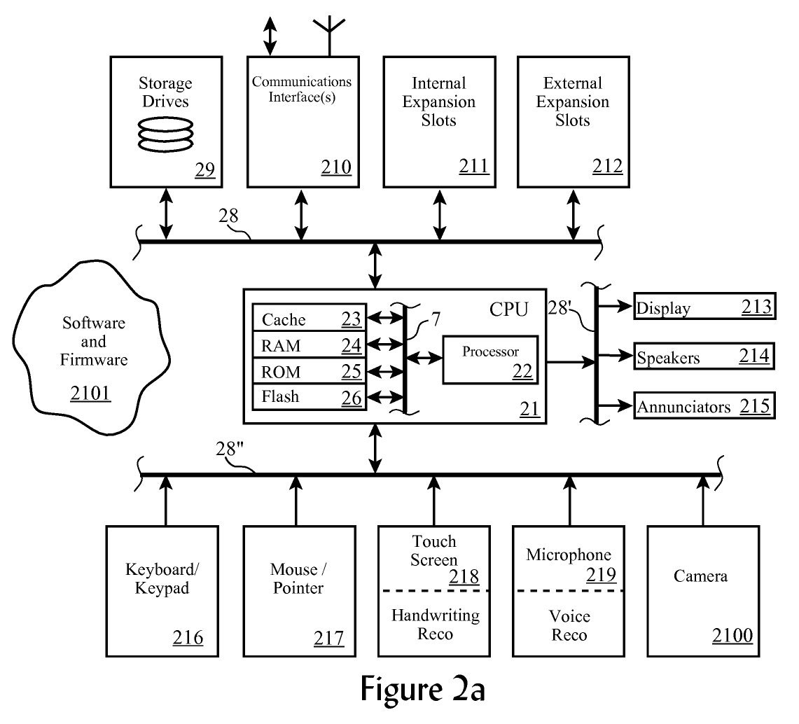

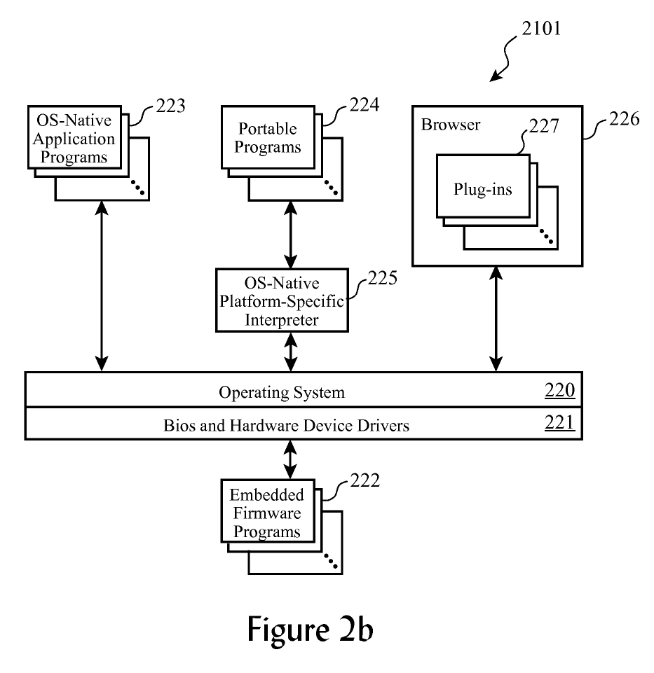

Turning to FIG. 2a, a generalized architecture is presented including a central processing unit (21) (“CPU”), which is typically comprised of a microprocessor (22) associated with random access memory (“RAM”) (24) and read-only memory (“ROM”) (25). Often, the CPU (21) is also provided with cache memory (23) and programmable FlashROM (26). The interface (27) between the microprocessor (22) and the various types of CPU memory is often referred to as a “local bus”, but also may be a more generic or industry standard bus.

Many computing platforms are also provided with one or more storage drives (29), such as hard-disk drives (“HDD”), floppy disk drives, compact disc drives (CD, CD-R, CD-RW, DVD, DVD-R, etc.), and proprietary disk and tape drives (e.g., I omega Zip™ and Jaz™, Addonics SuperDisk™, etc.). Additionally, some storage drives may be accessible over a computer network.

Many computing platforms are provided with one or more communication interfaces (210), according to the function intended of the computing platform. For example, a personal computer is often provided with a high speed serial port (RS-232, RS-422, etc.), an enhanced parallel port (“EPP”), and one or more universal serial bus (“USB”) ports. The computing platform may also be provided with a local area network (“LAN”) interface, such as an Ethernet card, and other high-speed interfaces such as the High Performance Serial Bus IEEE-1394.

Computing platforms such as wireless telephones and wireless networked PDA's may also be provided with a radio frequency (“RF”) interface with antenna, as well. In some cases, the computing platform may be provided with an infrared data arrangement (“IrDA”) interface, too.

Computing platforms are often equipped with one or more internal expansion slots (211), such as Industry Standard Architecture (“ISA”), Enhanced Industry Standard Architecture (“EISA”), Peripheral Component Interconnect (“PCI”), or proprietary interface slots for the addition of other hardware, such as sound cards, memory boards, and graphics accelerators.

Additionally, many units, such as laptop computers and PDA's, are provided with one or more external expansion slots (212) allowing the user the ability to easily install and remove hardware expansion devices, such as PCMCIA cards, SmartMedia cards, and various proprietary modules such as removable hard drives, CD drives, and floppy drives.

Often, the storage drives (29), communication interfaces (210), internal expansion slots (211) and external expansion slots (212) are interconnected with the CPU (21) via a standard or industry open bus architecture (28), such as ISA, EISA, or PCI. In many cases, the bus (28) may be of a proprietary design.

A computing platform is usually provided with one or more user input devices, such as a keyboard or a keypad (216), and mouse or pointer device (217), and/or a touch-screen display (218). In the case of a personal computer, a full size keyboard is often provided along with a mouse or pointer device, such as a track ball or TrackPoint™. In the case of a web-enabled wireless telephone, a simple keypad may be provided with one or more function-specific keys. In the case of a PDA, a touch-screen (218) is usually provided, often with handwriting recognition capabilities.

Additionally, a microphone (219), such as the microphone of a web-enabled wireless telephone or the microphone of a personal computer, is supplied with the computing platform. This microphone may be used for simply reporting audio and voice signals, and it may also be used for entering user choices, such as voice navigation of web sites or auto-dialing telephone numbers, using voice recognition capabilities.

Many computing platforms are also equipped with a camera device (2100), such as a still digital camera or full motion video digital camera.

One or more user output devices, such as a display (213), are also provided with most computing platforms. The display (213) may take many forms, including a Cathode Ray Tube (“CRT”), a Thin Flat Transistor (“TFT”) array, or a simple set of light emitting diodes (“LED”) or liquid crystal display (“LCD”) indicators.

One or more speakers (214) and/or annunciators (215) are often associated with computing platforms, too. The speakers (214) may be used to reproduce audio and music, such as the speaker of a wireless telephone or the speakers of a personal computer. Annunciators (215) may take the form of simple beep emitters or buzzers, commonly found on certain devices such as PDAs and PIMs.

These user input and output devices may be directly interconnected (28′, 28″) to the CPU (21) via a proprietary bus structure and/or interfaces, or they may be interconnected through one or more industry open buses such as ISA, EISA, PCI, etc. The computing platform is also provided with one or more software and firmware (2101) programs to implement the desired functionality of the computing platforms.

Turning to now FIG. 2b, more detail is given of a generalized organization of software and firmware (2101) on this range of computing platforms. One or more operating system (“OS”) native application programs (223) may be provided on the computing platform, such as word processors, spreadsheets, contact management utilities, address book, calendar, email client, presentation, financial and bookkeeping programs.

Additionally, one or more “portable” or device-independent programs (224) may be provided, which must be interpreted by an OS-native platform-specific interpreter (225), such as Java™ scripts and programs.

Often, computing platforms are also provided with a form of web browser or micro-browser (226), which may also include one or more extensions to the browser such as browser plug-ins (227).

The computing device is often provided with an operating system (220), such as Microsoft Windows™, UNIX, IBM OS/2™, IBM AIX™, open source LINUX, Apple's MAC OS™, or other platform specific operating systems. Smaller devices such as PDA's and wireless telephones may be equipped with other forms of operating systems such as real-time operating systems (“RTOS”) or Palm Computing's PalmOS™.

A set of basic input and output functions (“BIOS”) and hardware device drivers (221) are often provided to allow the operating system (220) and programs to interface to and control the specific hardware functions provided with the computing platform.

Additionally, one or more embedded firmware programs (222) are commonly provided with many computing platforms, which are executed by onboard or “embedded” microprocessors as part of the peripheral device, such as a micro controller or a hard drive, a communication processor, network interface card, or sound or graphics card.

As such, FIGS. 2a and 2b describe in a general sense the various hardware components, software and firmware programs of a wide variety of computing platforms, including but not limited to personal computers, PDAs, PIMs, web-enabled telephones, and other appliances such as WebTV™ units. As such, we now turn our attention to disclosure of the present invention relative to the processes and methods preferably implemented as software and firmware on such a computing platform. It will be readily recognized by those skilled in the art that the following methods and processes may be alternatively realized as hardware functions, in part or in whole, without departing from the spirit and scope of the invention.

### Computer-Readable Media Embodiments

In another embodiment of the invention, logical processes according to the invention and described herein are realized in computer program code encoded on or in one or more computer-readable media. Some computer-readable media are read-only (e.g. they must be initially programmed using a different device than that which is ultimately used to read the data from the media), some are write-only (e.g. from the data encoders perspective they can only be encoded, but not read simultaneously), or read-write. Still some other media are write-once, read-many-times.

Some media are relatively fixed in their mounting mechanisms, while others are removable, or even transmittable. All computer-readable media form two types of systems when encoded with data and/or computer software: (a) when removed from a drive or reading mechanism, they are memory devices which generate useful data-driven outputs when stimulated with appropriate electromagnetic, electronic, and/or optical signals; and (b) when installed in a drive or reading device, they form a data repository system accessible by a computer.

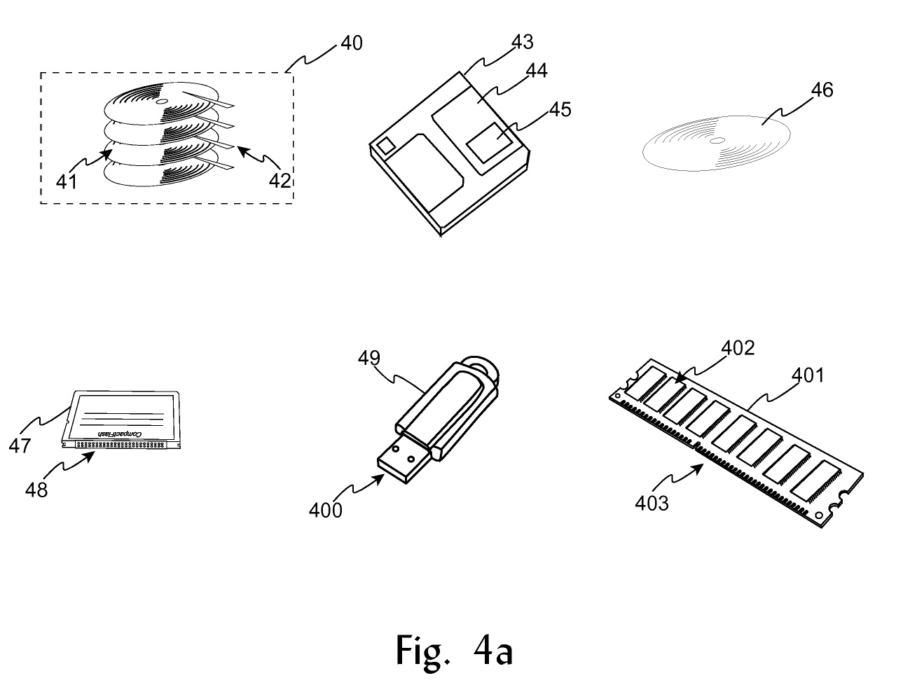

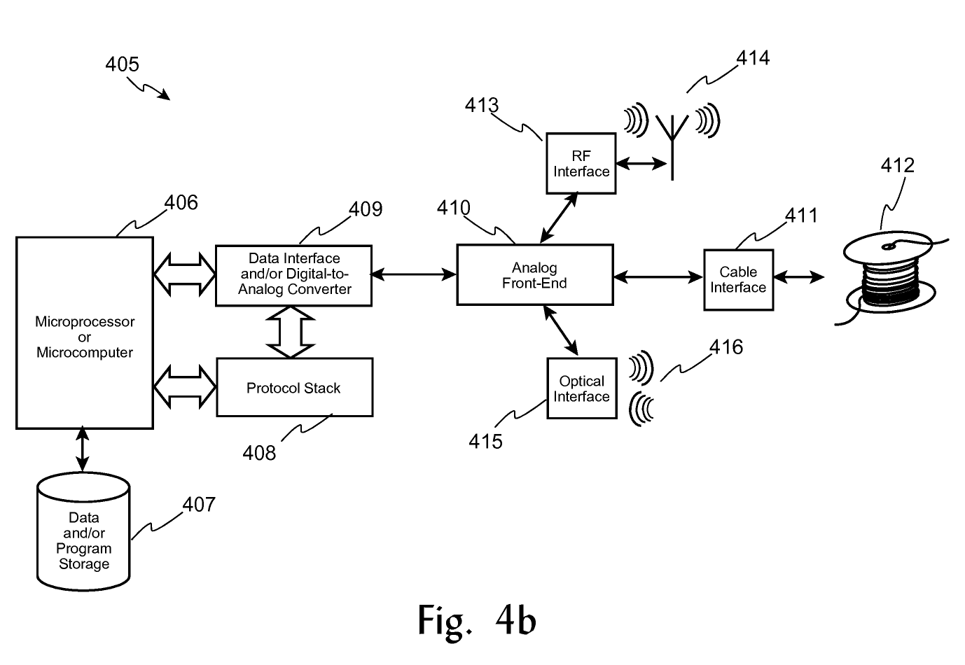

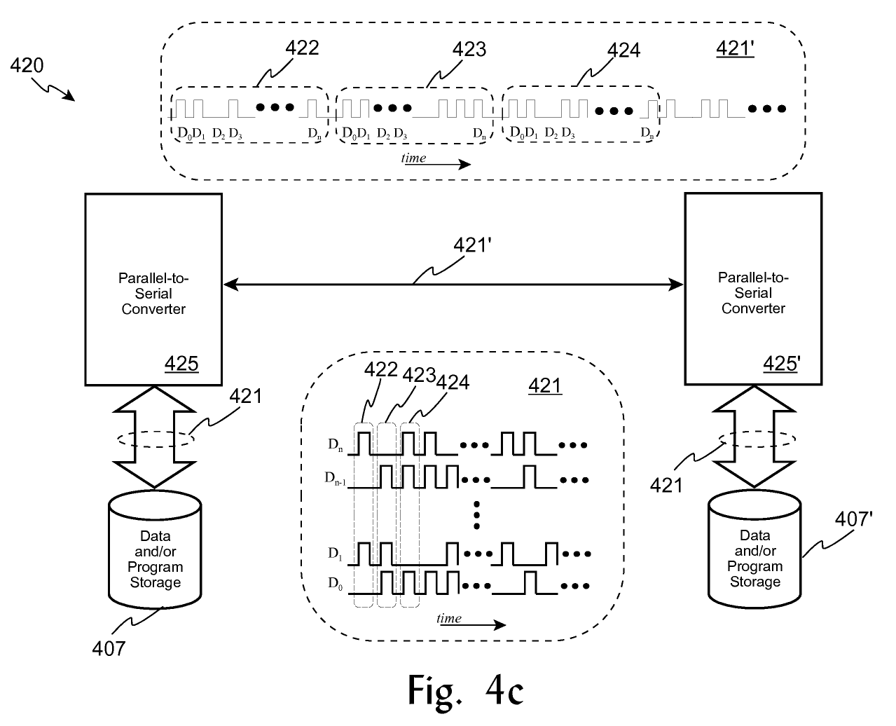

FIG. 4a illustrates some computer readable media including a computer hard drive (40) having one or more magnetically encoded platters or disks (41), which may be read, written, or both, by one or more heads (42). Such hard drives are typically semi-permanently mounted into a complete drive unit, which may then be integrated into a configurable computer system such as a Personal Computer, Server Computer, or the like.

Similarly, another form of computer readable media is a flexible, removable “floppy disk” (43), which is inserted into a drive which houses an access head. The floppy disk typically includes a flexible, magnetically encodable disk which is accessible by the drive head through a window (45) in a sliding cover (44).

A Compact Disk (“CD”) (46) is usually a plastic disk which is encoded using an optical and/or magneto-optical process, and then is read using generally an optical process. Some CD's are read-only (“CD-ROM”), and are mass produced prior to distribution and use by reading-types of drives. Other CD's are writable (e.g. “CD-RW”, “CD-R”), either once or many time. Digital Versatile Disks (“DVD”) are advanced versions of CD's which often include double-sided encoding of data, and even multiple layer encoding of data. Like a floppy disk, a CD or DVD is a removable media.

Another common type of removable media are several types of removable circuit-based (e.g. solid state) memory devices, such as Compact Flash (“CF”) (47), Secure Data (“SD”), Sony's MemoryStick, Universal Serial Bus (“USB”) FlashDrives and “Thumbdrives” (49), and others. These devices are typically plastic housings which incorporate a digital memory chip, such as a battery-backed random access chip (“RAM”), or a Flash Read-Only Memory (“FlashROM”). Available to the external portion of the media is one or more electronic connectors (48, 400) for engaging a connector, such as a CF drive slot or a USB slot. Devices such as a USB FlashDrive are accessed using a serial data methodology, where other devices such as the CF are accessed using a parallel methodology. These devices often offer faster access times than disk-based media, as well as increased reliability and decreased susceptibility to mechanical shock and vibration. Often, they provide less storage capability than comparably priced disk-based media.

Yet another type of computer readable media device is a memory module (403), often referred to as a SIMM or DIMM. Similar to the CF, SD, and FlashDrives, these modules incorporate one or more memory devices (402), such as Dynamic RAM (“DRAM”), mounted on a circuit board (401) having one or more electronic connectors for engaging and interfacing to another circuit, such as a Personal Computer motherboard. These types of memory modules are not usually encased in an outer housing, as they are intended for installation by trained technicians, and are generally protected by a larger outer housing such as a Personal Computer chassis.

Turning now to FIG. 4b, another embodiment option (405) of the present invention is shown in which a computer-readable signal is encoded with software, data, or both, which implement logical processes according to the invention. FIG. 4b is generalized to represent the functionality of wireless, wired, electro-optical, and optical signaling systems. For example, the system shown in FIG. 4b can be realized in a manner suitable for wireless transmission over Radio Frequencies (“RF”), as well as over optical signals, such as InfraRed Data Arrangement (“IrDA”). The system of FIG. 4b may also be realized in another manner to serve as a data transmitter, data receiver, or data transceiver for a USB system, such as a drive to read the aforementioned USB FlashDrive, or to access the serially-stored data on a disk, such as a CD or hard drive platter.

In general, a microprocessor or microcontroller (406) reads, writes, or both, data to/from storage for data, program, or both (407). A data interface (409), optionally including a digital-to-analog converter, cooperates with an optional protocol stack (408), to send, receive, or transceive data between the system front-end (410) and the microprocessor (406). The protocol stack is adapted to the signal type being sent, received, or transceived. For example, in a Local Area Network (“LAN”) embodiment, the protocol stack may implement Transmission Control Protocol/Internet Protocol (“TCP/IP”). In a computer-to-computer or computer-to-peripheral embodiment, the protocol stack may implement all or portions of USB, “FireWire”, RS-232, Point-to-Point Protocol (“PPP”), etc.

The system's front-end, or analog front-end, is adapted to the signal type being modulated, demodulate, or transcoded. For example, in an RF-based (413) system, the analog front-end comprises various local oscillators, modulators, demodulators, etc., which implement signaling formats such as Frequency Modulation (“FM”), Amplitude Modulation (“AM”), Phase Modulation (“PM”), Pulse Code Modulation (“PCM”), etc. Such an RF-based embodiment typically includes an antenna (414) for transmitting, receiving, or transceiving electromagnetic signals via open air, water, earth, or via RF wave guides and coaxial cable. Some common open air transmission standards are BlueTooth, Global Services for Mobile Communications (“GSM”), Time Division Multiple Access (“TDMA”), Advanced Mobile Phone Service (“AMPS”), and Wireless Fidelity (“Wi-Fi”).

In another example embodiment, the analog front-end may be adapted to sending, receiving, or transceiving signals via an optical interface (415), such as laser-based optical interfaces (e.g. Wavelength Division Multiplexed, SONET, etc.), or infra Red Data Arrangement (“IrDA”) interfaces (416). Similarly, the analog front-end may be adapted to sending, receiving, or transceiving signals via cable (412) using a cable interface, which also includes embodiments such as USB, Ethernet, LAN, twisted-pair, coax, Plain-old Telephone Service (“POTS”), etc.

Signals transmitted, received, or transceived, as well as data encoded on disks or in memory devices, may be encoded to protect it from unauthorized decoding and use. Other types of encoding may be employed to allow for error detection, and in some cases, correction, such as by addition of parity bits or Cyclic Redundancy Codes (“CRC”). Still other types of encoding may be employed to allow directing or “routing” of data to the correct destination, such as packet and frame-based protocols.

FIG. 4c illustrates conversion systems which convert parallel data to and from serial data. Parallel data is most often directly usable by microprocessors, often formatted in 8-bit wide bytes, 6-bit wide words, 32-bit wide double words, etc. Parallel data can represent executable or interpretable software, or it may represent data values, for use by a computer. Data is often serialized in order to transmit it over a media, such as a RF or optical channel, or to record it onto a media, such as a disk. As such, many computer-readable media systems include circuits, software, or both, to perform data serialization and re-parallelization.

Parallel data (421) can be represented as the flow of data signals aligned in time, such that parallel data unit (byte, word, d-word, etc.) (422, 423, 424) is transmitted with each bit D₀-Dₙ being on a bus or signal carrier simultaneously, where the “width” of the data unit is n−1. In some systems, D₀ is used to represent the least significant bit (“LSB”), and in other systems, it represents the most significant bit (“MSB”). Data is serialized (421) by sending one bit at a time, such that each data unit (422, 423, 424) is sent in serial fashion, one after another, typically according to a protocol.

As such, the parallel data stored in computer memory (407, 407′) is often accessed by a microprocessor or Parallel-to-Serial Converter (425, 425′) via a parallel bus (421), and exchanged (e.g. transmitted, received, or transceived) via a serial bus (421′). Received serial data is converted back into parallel data before storing it in computer memory, usually. The serial bus (421′) generalized in FIG. 4c may be a wired bus, such as USB or Firewire, or a wireless communications medium, such as an RF or optical channel, as previously discussed.

In these manners, various embodiments of the invention may be realized by encoding software, data, or both, according to the logical processes of the invention, into one or more computer-readable mediums, thereby yielding a product of manufacture and a system which, when properly read, received, or decoded, yields useful programming instructions, data, or both, including, but not limited to, the computer-readable media types described in the foregoing paragraphs.

### Conclusion

While certain examples and details of a preferred embodiment have been disclosed, it will be recognized by those skilled in the art that variations in implementation such as use of different programming methodologies, computing platforms, and processing technologies, may be adopted without departing from the spirit and scope of the present invention. Therefore, the scope of the invention should be determined by the following claims.

What is claimed is:

1. An automated method for determining a potential multicomputer related problem comprising the steps of:
determining and storing in a configuration management database a set of relationships between a set of computer resources needed to complete a multicomputer business transaction;
retrieving said resource relationships;
retrieving a set of performance monitoring metrics for the set of computer resources during executions of the multicomputer business transaction;
dynamically deriving correlations between the sets of resource relationships and the performance metrics;
comparing a trend of one or more correlations to one or more service level requirements to predict one or more potential future violations of a business transaction requirement, including identification of one or more related resources likely to cause said violation; and
reporting to an administrator of said computer resources said violation prediction and said likely cause identification.

2. The method as set forth in claim 1 further comprising providing a plurality of personas which identify one or more monitored metrics as key metrics, and in which said step of reporting further comprises reporting related non-key metrics that impact each key metric.

3. The method as set forth in claim 2 in which said step of reporting impacts to key metrics comprises a separate alert containing only said key metric report.

4. The method as set forth in claim 1 further comprising employing discovery methods to detect a normal state of the performance metrics.

5. The method as set forth in claim 1 further comprising:
automatically generating correlation rules;
present said rules to an administrator;
receiving one or more indications from said administrator designating which rules are deemed important to one or more business entities; and
wherein said step of reporting further comprises providing an indication of business entity impact according to said rules and importance designations.

6. The method as set forth in claim 1 further comprising automatic identification of causal relationships of errors and metric insufficiencies over time.

7. The method as set forth in claim 6 where said identification of causal relationship identification comprises selecting a source for a metric which is predicted to be insufficient first as a probable cause.

8. The method as set forth in claim 1 further comprising providing and employing one or more templates for correlation patterns.

9. The method as set forth in claim 2 further comprising tracking one or more unmonitored metrics in order to detect missing or lacking of monitoring, and responsive to determination that a key metric has spiked or dipped abnormally when no other metrics have abnormally spiked or dipped in correlation, determining and reporting that said lack of monitoring of the spiked or dipped key metric is a likely cause of the spike or dip due to a lurking variable or confounding factor.

10. A computer-based system for determining a potential multicomputer related problem comprising the steps of:
a first data storage subsystem containing performance monitoring metrics collected from components of a multicomputer business transaction arrangement;
a second data storage subsystem containing a plurality of relationship definitions for said components for completing a business transaction; and
a correlation agent portion of a computer platform, having access to said first and second data storage subsystems, and being configured to:
(a) retrieve said resource relationships and a set of performance monitoring metrics for a set of components operated during executions of the multicomputer business transaction;
(b) dynamically derive correlations between the set of resource relationships and the performance metrics;
(c) compare a trend of one or more correlations to one or more service level requirements to predict one or more potential future violations of a business transaction requirement, including identification of one or more related components likely to cause said violation; and
(d) report to an administrator of said computer resources said violation prediction and said likely cause identification.

11. The system as set forth in claim 10 further comprising a plurality of personas which identify one or more monitored metrics as key metrics, and in which said correlation agent is further configured to report related non-key metrics that impact each key metric.

12. The system as set forth in claim 10 in which said correlation agent is further configured to automatically generate correlation rules, to present said rules to an administrator, to receive one or more indications from said administrator designating which rules are deemed important to one or more business entities, and to report including indications of business entity impact according to said rules and importance designations.

13. The system as set forth in claim 10 wherein said correlation agent is further configured to automatically identify causal relationships of errors and metric insufficiencies over time.

14. The system as set forth in claim 13 where said identification of causal relationship identification comprises selecting a source for a metric which is predicted to be insufficient first as a probable cause.

15. The system as set forth in claim 11 wherein said correlation agent is further configured to track one or more unmonitored metrics in order to detect missing or lacking of monitoring, and responsive to determination that a key metric has spiked or dipped abnormally when no other metrics have abnormally spiked or dipped in correlation, to determine and report that said lack of monitoring of the spiked or dipped key metric is a likely cause of the spike or dip due to a lurking variable or confounding factor.

16. An article of manufacture for determining a potential multicomputer related problem comprising:
a computer-readable medium suitable for encoding computer programs; and
one or more computer programs encoded by said medium and configured to cause a processor to perform the steps of:
(a) determining and storing in a configuration management database a set of relationships between a set of computer resources needed to complete a multicomputer business transaction;
(b) retrieving said resource relationships;
(c) retrieving a set of performance monitoring metrics for the set of computer resources during executions of the multicomputer business transaction;
(d) dynamically deriving correlations between the sets of resource relationships and the performance metrics;
(e) comparing a trend of one or more correlations to one or more service level requirements to predict one or more potential future violations of a business transaction requirement, including identification of one or more related resources likely to cause said violation; and
(f) reporting to an administrator of said computer resources said violation prediction and said likely cause identification.

17. The article as set forth in claim 16 further comprising a program configured to provide a plurality of personas which identify one or more monitored metrics as key metrics, and in which said program for reporting further comprises program for reporting related non-key metrics that impact each key metric.

18. The article as set forth in claim 16 further comprising program configured to:
automatically generate correlation rules;
present said rules to an administrator;
receive one or more indications from said administrator designating which rules are deemed important to one or more business entities; and
wherein said program for reporting further comprises program for providing an indication of business entity impact according to said rules and importance designations.

19. The article as set forth in claim 16 further comprising automatic identification of causal relationships of errors and metric insufficiencies over time.

20. The article as set forth in claim 17 further comprising program configured to track one or more unmonitored metrics in order to detect missing or lacking of monitoring, and responsive to determination that a key metric has spiked or dipped abnormally when no other metrics have abnormally spiked or dipped in correlation, to determine and report that said lack of monitoring of the spiked or dipped key metric is a likely cause of the spike or dip due to a lurking variable or confounding factor.
